(19) United States
(12) Patent Application Publication
(10) Pub. No.: US 2009/0231156 A1
(43) Pub. Date: Sep. 17, 2009

(54) Audible reminder device

(76) Inventor: Jeannette P. Twomey, Vienna, VA (US)

Correspondence Address: ROGER M. RATHBUN, 13 MARGARITA COURT, HILTON HEAD ISLAND, SC, 29926, US

(21) Appl. No.: 12/075,366

(22) Filed: Mar. 11, 2008

(51) Int. Cl. G08B 3/00; G09B 21/00

(52) U.S. Cl. 340/825.19; 340/384.1

(57) ABSTRACT

An audible reminder device for providing an audible message to a user, particularly a user having impaired memory and reasoning capacity. The audible reminder device has a housing with two oppositely facing outer surfaces. On one outer surface, there is a playback button that is large and prominent with respect to the housing surface and there are no other user operable components on that surface. The playback button can also be of a contrasting color to the housing. On the other outer surface, there is an activation button that enables a person to erase any current stored message and record a new message. The playback button is simple and easy to recognize and when pushed, repeats the same message until that message is erased and a new message recorded.

### BACKGROUND OF THE INVENTION

The present invention is a reminder device for individuals. It is specifically designed for simple, uncomplicated operation by persons with diminished capacity. A recordable message may be stored in its memory for easy electronic recall by the depression of a single, oversized button. New messages may be recorded throughout a day to meet changing needs. The device brings useful and comforting information to the attention of a person who suffers mild to moderate loss of memory and reasoning ability.

There are, today, an increasing number of individuals who are experiencing diminished memory and reasoning function as they age. There are currently 5.1 million patients in the United States suffering from Alzheimer's disease, a serious, progressive form of dementia. More than half of these individuals are cared for by relatives or trained service providers in a home environment.

Those in mild to moderate stages of dementia can still carry on many activities of daily life with repeated prompting and oversight. The challenging role of their caregivers is to reduce the patient's confusion and anxiety by helping them stay oriented to what is going on around them. For example, such a person may need to be reminded multiple times during an hour's time that they are not alone, that they have eaten their meals, that they have taken medication, that they have an appointment, or that they need to go to bed. This constant reminding is tedious and frustrating and a documented cause of caregiver burnout.

This reminder device adds a tool that has been missing from the caregiver's toolkit. It eases caregiver burden and frustration by giving the patient an alternative source of comforting information. Patients with mild to moderate memory and reasoning loss retain the initiative and ability to seek out helpful information from the device. They can remember that the device offers help when they experience uncertainty, and they can retain the concept of depressing the device's single, oversized button for assistance. They benefit from hearing a reassuring message and their caregiver's familiar voice.

There are a number of reminder devices in existence. However, many are intended for use by fully competent persons. It is relatively complicated to enter and retrieve the desired reminders in these devices. Others need to be programmed by a sophisticated computer system, and still others simply provide a visual notice to an individual.

Accordingly, it would be advantageous to have a reminder device that is extremely simple to operate, so that the person with diminished capacity can retrieve comforting messages at will.

It would also be advantageous if such device were capable of recording a message that is delivered to the person audibly and, preferably, by a familiar voice to enhance reliance on the device. It would be further advantageous to activate the message by means of a single, oversized button on a surface of the device. Such a button, unencumbered by the presence of other buttons or confusing components, would enable the user to confidently and reliably seek helpful information by activating the device.

It would be still further advantageous to have such a reminder device that is sufficiently small and portable so that it might be hung in the manner of a pendent around the neck of the user. This feature makes the device conveniently accessible to the user at all times during the day.

### SUMMARY OF THE INVENTION

The present invention provides an audible reminder device that provides information that is comforting and reassuring for a user. This device has a housing that is sufficiently small so as to contain all of the necessary components needed to carry out the messaging system and yet be compact and lightweight enough to be carried by the patient in the manner of a pendent, that is, suspended by a lanyard that encircles the neck of the user.

The housing itself has two opposed principal outer surfaces. There is provided on one of those surfaces, an activation device, such as an activation button, that can be pushed to allow a person to record a message into a storage media contained within the housing. On the opposite surface, there is provided another activation device, such as a playback button, that can be pushed by the user to enable the reminder device to play an audible message that is stored in the storage media. The playback button itself is relatively large and can take up about 20-30 percent of the entire area of that outer surface in which it is located. More preferably, it should take up at least 20 percent of that area and still more preferably about 23 percent of the surface of the outer surface where it is located.

As such, the one outer surface has only one playback button and no other controls, switches or components that could cause confusion on the part of a user with a diminished capacity. On the other hand, all of the activation devices or controls necessary to carry out the recording of a message are then located on the opposite outer surface and are more inaccessible to the user so as not to confuse the user into pushing an erroneous button.

Within the housing there is an input device, such as a microphone, that inputs the audible message to a storage media where the message is stored in electronic form. When the playback button is activated, that stored message is played via a playback device to produce an audible message. As an advantage, not only is an audible message relatively easy for the user to follow and understand, the message can potentially be recorded by a person with whom the user is familiar. This adds some recognition and assurance that the message is legitimate and understandable.

Other features of the present audible reminder device will become apparent in light of the following detailed description of a preferred embodiment thereof and as illustrated in the accompanying drawings.

### BRIEF DESCRIPTION OF THE DRAWINGS

FIG. 1 is a front view of an audible reminder device of the present invention;

FIG. 2 is a rear view of the device of FIG. 1;

FIG. 3 is a side view of the device of FIG. 1;

FIG. 4 is a cross-sectional view of the device of FIG. 1 taken along the line 4-4 of FIG. 1; and

FIG. 5 is a schematic view of a printed circuitboard usable with the present invention.

### DETAILED DESCRIPTION OF THE INVENTION

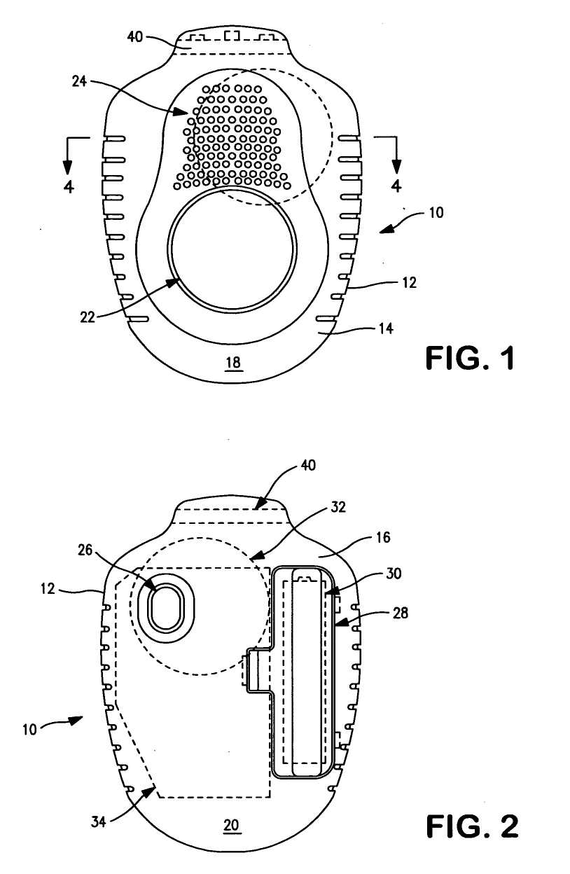

Referring now to FIGS. 1 and 2, there is shown a front view and rear view, respectively, of the audible reminder device 10 constructed in accordance with the present invention. As can be seen, the audible reminder device 10 comprises a housing 12 that is made up of two split housings 14 and 16, each, therefore, presenting an outer surface 18, 20 that are oppositely disposed with respect to each other. Both split housings 14, 16 can be injection molded plastic components and can snap together to complete the housing 10, however, other arrangements of components could be constructed and used to make up a complete housing 12.

There is also provided on the outer surface 18, a playback button 22 that takes up a relatively large area with respect to the overall area of the outer surface 18 for a purpose what will later be described. In the exemplary embodiment, the area of the playback button 22 is about 20-30 percent of the overall area of the outer surface 18 of split housing 14, preferably at least 20 percent and, more preferably about 23 percent. There is also provided on the outer surface 18, holes 24 for a speaker to allow the sound from a speaker to pass outwardly through the outer surface 18 of the housing 12.

Taking then the outer surface 20 of the other split housing 16, there can be seen an activation button 26 that is considerably smaller that the playback button 22 and less accessible to a user. There is also a battery door 28 in the outer surface 20 and which allows the replacement of a battery for the device. In general, the audible reminder device of the present invention can be operated with a single AAA battery 30.

There can also be seen in FIG. 2, a speaker 32 that is located internal of the housing 12 as well as a printed circuitboard 34 in order to carry out the functioning of the present invention.

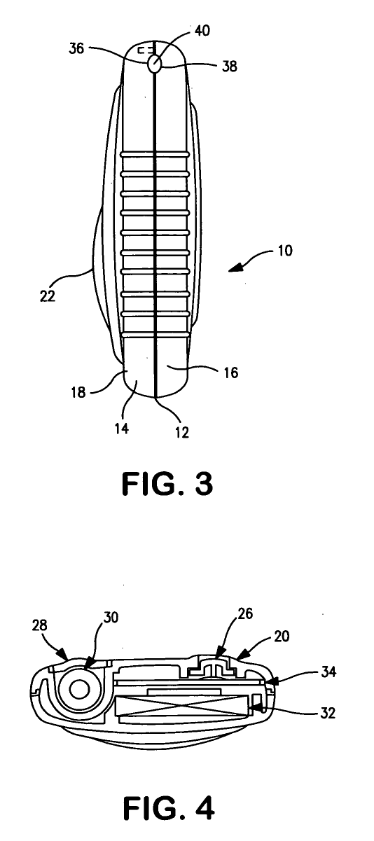

Turning now to FIG. 3, taken along with FIGS. 1 and 2, it can be seen that in this exemplary embodiment, the playback button 22 extends outwardly from the outer surface 18 to facilitate the pressing of the playback button 22 by the user. In an exemplary embodiment, the color of the playback button 22 can be contrastingly different than that of the housing 12 so that it stands out and is very visible to the user. For example, the housing 10 can be a light color with the playback button 22 a dark color, or the reverse may be used, it begin important that the playback button 22 be a significant and readily recognizable target for the user to push in order to listen to an audible message.

There are also semi-cylindrical openings 36, 38 formed, respectively, in the split housing 14 and the split housing 16 such that, upon joining those split housings together, there is formed a tunnel 40 through which a halyard can be passed for encircling the neck of a user such that the user can wear the audible reminder device 10 much in the manner of a pendant.

As such, the audible reminder device 10 can simply be worn by a user around the neck and always be present and accessible for use by the user and the size and location of the audible reminder device 10 is such that it does not prevent the user from carrying out any normal functions. In an exemplary embodiment, the audible reminder device 10 is elliptical in shape and having dimensions of about 2 inches wide by 3 inches high. In the preferred embodiment, the area of the playback button 22 is about 20-30 percent of the area of the outer surface 18 of the housing 12, and more preferably, at least 20 percent of that area, and still more preferably about 23 percent of that area such that the size or area of the playback button 22 is relatively large with respect to the area of the surface in which it is located.

Turning next to FIG. 4, there is shown a horizontal cross sectional view of the present audible reminder device 10 taken along the line 44 of FIG. 1. In FIG. 4, it can be seen that the activation button 26 is recessed inwardly from the outer surface 20 so that it is not easily activated but requires some deliberate pushing to displace the activation button 26 inwardly.

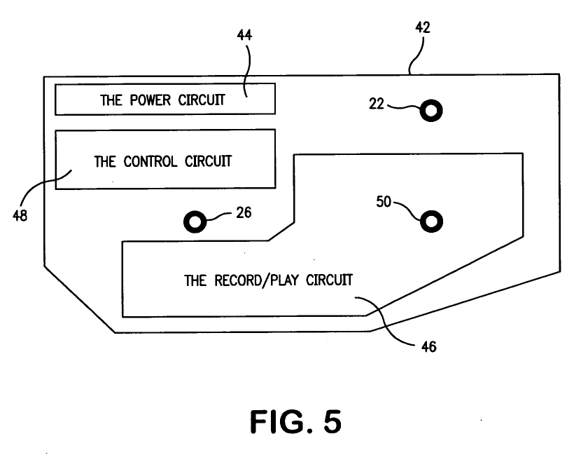

Turning finally to FIG. 5, taken along with FIG. 14, there is shown a schematic view of a typical printed circuitboard 42 circuitry that can be used with the present invention. As can be seen, there are three basic circuits, the power circuit 44, the record/play circuit 46 and the control circuit 48. The power circuit 44 is provided in order to raise the voltage from the 1.5 volts provided by an AAA battery to 5 volts for use in powering the device. The record/play circuit 46 in the record mode, collects the speech signals from the microphone 50, then amplifies and converts the signals from analog to digital form and stores those digital signals in a storage media. In the play mode, the digital signal are converted from digital form back to analog form and then amplified and played through the speaker 32.

With the control circuit 48, the control circuit 48 is controlled by only two buttons, the playback button 22 and the activation button 26 that is depressed for the recording and erasing functions. When the activation button 26 is depressed and held, the circuit operates to first send a pulse signal to delete or erase the hold message then activates the record/play circuit 46 into the record mode until the activation button 26 is released.

The volume of the audio signal from the speaker 32 is preset, thereby eliminating the option to the user and thereby avoiding further confusion. In effect, the audible message device 10 is a one button operation for the user such that a person having limited faculties can readily operate the device.

As such, the overall audible reminder device 10 is designed to be usable by one having an impaired memory or reasoning function and to present a very simple, non-complicated means of receiving the message. It is also calm-inducing since the audible message can be delivered by a voice that is familiar to the user.

A message can be easily recorded by a caregiver. The same message can continue to be played upon each activation of the playback button 22, until a new message is recorded and the current message erased. Thus, the original message can be accessed multiple times during the course of a day by the user, or the caregiver can change the message as needed to maintain the user's orientation to daily activities It will be understood that the scope of the invention is not limited to the particular embodiment disclosed herein, by way of example, but only by the scope of the appended claims.

What is claimed is:

1. An audible reminder device for providing a message to a user, the reminder device comprising a housing having oppositely facing first and second outer surfaces, a storage media located within the housing, an electronic circuit located within the housing adapted to record an audible message for entry into the storage media and to produce an audible playback of a message stored in the storage media, an activation button located along the second outer surface to activate the electronic circuit to enable the recording of an audible message and a playback button located along the first outer surface to activate the playback device to play an audible message stored in the storage media.

2. The audible reminder device as defined in claim 1 wherein the activation button is recessed inwardly with respect to the second outer surface.

3. The audible reminder device as defined in claim 1 wherein the playback button extends outwardly with respect to the first outer surface.

4. The audible reminder device as defined in claim 1 wherein the activation button can be pushed to erase any message then in the memory.

5. The audible reminder device as defined in claim 1 wherein the housing is elliptical in shape and having dimension of about 2 inches by 3 inches.

6. The audible reminder device as defined in claim 1 wherein the housing further contains an accessible source of electrical power.

7. The reminder device as defined in claim 1 wherein the housing is comprised of a pair of split housings affixed together.

8. The reminder device as defined in claim 1 wherein the activation button and the housing are of contrasting colors.

9. The reminder device of claim 1 wherein the area of the playback button is about 20-30 percent of the area of the first outer surface of the housing.

10. The reminder device of claim 1 wherein the area of the playback button is at least 20 percent of the area of the first outer surface of the housing.

11. The reminder device of claim 9 wherein the area of the playback button is about 23 percent of the area of the first outer surface of the housing.

12. The reminder device of claim 1 wherein the playback button is the sole activation component on the means located on the first outer surface.

13. A method of providing a message to a user, the method comprising the steps of:
providing a audible message device having oppositely facing a first and second outer surfaces, and enclosing therein an electronic storage media, an electronic circuit adapted to record an audible message for entry into the storage media and to produce an audible playback of a message stored in the storage media, the device having an activation button located along the second outer surface and a playback button located along the first outer surface,
activating the electronic circuit by pressing on the activation button to record a message; and
pushing the playback button to play a message that is stored in the storage media.

14. The method of claim 13 wherein the step of providing an audible message device comprises providing an audible message device having a housing of a contrasting color to the playback button.

15. The method of claim 13 wherein the step of activating the electronic circuit to record a message further comprises the step of erasing any prior message then in the storage media.

16. The method of claim 13 wherein the step of providing an audible message device comprises providing a playback button that has an area between about 20 and 30 percent of the area of the first outer surface.

17. The method of claim 16 wherein the step of providing an audible message device comprises providing a playback button that has an area at least 20 percent of the area of the first outer surface.

18. The method of claim 16 wherein the step of providing an audible message device comprises providing an playback button that has an area about 23 percent of the area of the first outer surface.
